(19) United States
(12) Patent Application Publication
(10) Pub. No.: US 2010/0325017 A1
(43) Pub. Date: Dec. 23, 2010

(54) ONLINE BIDDING SYSTEM, METHOD AND COMPUTER PROGRAM PRODUCT

(76) Inventor: Charlie Hrach Mirzakhanyan, Glendale, CA (US)

Correspondence Address: The Villamar Firm PLLC, 3424 Washington Drive, Falls Church, VA, 22041, US

(21) Appl. No.: 12/818,260

(22) Filed: Jun. 18, 2010

Related U.S. Application Data
(60) Provisional application No. 61/213,554, filed on Jun. 19, 2009.

(51) Int. Cl. G06Q 30/00; G06Q 50/00

(52) U.S. Cl. 705/27

(57) ABSTRACT

A system, method and computer program product for online bidding for vehicle purchases, including a server configured to receive a vehicle request specifying a vehicle desire to be purchased from a buyer computer device. The server is configured to transmit the vehicle request to one or more computer devices of vehicle sellers. The server is configured to receive bids based on the vehicle specified in the vehicle request from the computer devices of the vehicle sellers. The server is configured to display bids received from the one or more computer devices of the vehicle sellers on the computer device of the buyer and the computer devices of the vehicle sellers.

### CROSS REFERENCE TO RELATED APPLICATIONS

The present invention claims benefit of priority to U.S. Provisional Patent Application Ser. No. 61/213,554 of MIRZAKHANYAN, entitled “ONLINE SYSTEM/WEBSITE WHERE DEALERSHIPS COMPETE FOR THE CUSTOMER′S BUSINESS BY UNDERBIDDING THE COMPETITION,” filed on Jun. 19, 2009, the entire disclosure of which is hereby incorporated by reference herein.

### BACKGROUND OF THE INVENTION

1. Field of the Invention

The present invention generally relates to online bidding systems and methods, and more particularly to an improved online bidding system and method for buyers to purchase vehicles from car dealerships.

2. Discussion of the Background

Currently, the general process of purchasing a vehicle includes selecting a dealership to visit, selecting a vehicle, completing a credit check, and negotiating pricing with a salesperson. Once the negotiation starts, the salesperson does not have the final word, as their role is one of a messenger. For example, multiple consultations from the finance department can occur prior to finalizing a price. Furthermore, the customer is unable to easily compare vehicle prices with those of other dealerships during this process. This, to the detriment of a consumer, allows a dealership to make as much as profit as possible and potentially pressure the consumer. This process can possibly take several hours. In addition, the consumer may not have any knowledge of other potential offers and if the consumer wants to go to several dealerships to find out their prices, they must go through the above process with each one.

Should the consumer decide to shop around, this is very time consuming, including having to travel from one dealership to another, as well as calling multiple dealers to see who can offer the best price. The purchasing process and competition amongst dealerships creates an atmosphere where information is vague and/or hidden from the consumer. For example, the consumer is not given a copy of their credit report nor written offers/estimate due to the likelihood that it can be useful to competitors. Often times, dealerships will not disclose accurate prices because they are aware of consumers shopping around. In addition, consumers are hesitant about having multiple credit application inquiries, which cause points to be deducted from their credit (e.g., FICO) score. Furthermore, consumers often receive various calls, emails and mail from different dealerships and brokers who contact them at inconvenient times.

In addition, systems and methods for purchasing have expanded to the internet. For example, there are a number of online sites that specialize in auctioning and bidding. However, these sites typically are based on direct bidding by the buyer. Such websites, for example, include eBay.com, eBid.com, ePier.com, OnlineAuction.com, Overstock.com, uBid.com, and WeBidz.com. Other websites, such Cars.com, Edmunds.com, and KBB.com specialize in specific types of products (e.g., automotive) and use a method of “lead generation.” However, a problem with most of these sites is that they all require a great deal of involvement from the buyer in order to educate themselves, select, and bid on products that are complex and involve multiple specifications, such as automobiles. Many of these websites simply collect customer names, phone numbers and information on cars that the customers are interested in. After such information is collected, these websites simply send the lead information to car dealers. Once the dealerships receive the lead, they will try to contact the customer. Such processes are not much different from a customer calling or going to dealerships and include the same and other disadvantages.

All of the above indicates that there is a need for improved systems and methods for vehicle purchase that are reliable, cost effective, and that provide improved performance, as compared to conventional systems and methods.

### SUMMARY OF THE INVENTION

Therefore, there is a need improved methods and systems for vehicle purchase that address the above and other problems with conventional systems and methods. The above and other needs are addressed by the exemplary embodiments of the present invention, which provide an improved online bidding system and method for buyers to purchase vehicles from car dealerships. In an exemplary embodiment, a buyer submits a request for a vehicle the buyer wishes to purchase to a web server, then the buy request is sent by the web server to one or more car dealerships and/or brokers. The car dealerships and/or brokers can bid against each other via the web server, advantageously, to provide the lowest possible price to the buyer for the requested or similar vehicle.

Accordingly, in exemplary aspects of the present invention, there are provided a system, method and computer program product for online bidding system for vehicle purchases, including a server that can be configured to receive a vehicle request specifying a vehicle desire to be purchased from a buyer computer device. The server can be configured to transmit the vehicle request to one or more computer devices of vehicle sellers. The server can be configured to receive bids based on the vehicle specified in the vehicle request from the computer devices of the vehicle sellers. The server can be configured to display bids received from the one or more computer devices of the vehicle sellers on the computer device of the buyer and the computer devices of the vehicle sellers.

The server can be configured to receive from the computer device of the buyer an acceptance of a bid of the received bids and forward the bid acceptance to the corresponding computer device of the vehicle seller that made the accepted bid.

The server can be configured to allow one or more rounds of bidding from the computer devices of the vehicle sellers.

The server can be configured to receive from the computer device of the buyer an auction end request for ending the bidding from the computer devices of the vehicle sellers.

The server, before commencing the bidding, can be configured to qualify the buyer, based on credit information of the buyer received from the computer device of the buyer, and qualify the sellers, based on information regarding the sellers received from the computer devices of the sellers.

Advantageously, with the system, method and computer program product for online bidding for vehicle purchases, the vehicle sellers can bid against each other via the server to provide the lowest possible price to the buyer for the requested vehicle.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates an exemplary online bidding system for vehicle purchases, according to an exemplary embodiment;

FIG. 2 illustrates an exemplary online bidding method for vehicle purchases corresponding to the system of FIG. 1, according to an exemplary embodiment;

FIGS. 3A-3C illustrate exemplary web pages of the exemplary online bidding system and method for vehicle purchases of FIGS. 1-2, according to exemplary embodiments;

FIG. 4 illustrates exemplary web page navigation for the exemplary online bidding system and method for vehicle purchases of FIGS. 1-3, according to exemplary embodiments;

FIGS. 5A-5D illustrate details of the exemplary online bidding system and method for vehicle purchases of FIGS. 1-4 for a customer, according to exemplary embodiments;

FIGS. 6A-6D illustrate details of the exemplary online bidding system and method for vehicle purchases of FIGS. 1-4 for a dealer, according to exemplary embodiments;

FIG. 7 illustrates further details of the exemplary online bidding system and method for vehicle purchases of FIGS. 1-6 for a buyer, according to an exemplary embodiment;

FIG. 8 illustrates further details of the exemplary online bidding system and method for vehicle purchases of FIGS. 1-6 for a seller, according to an exemplary embodiment; and

FIG. 9 illustrates further details of the exemplary online bidding system and method for vehicle purchases of FIGS. 1-6 for a winning bid, according to an exemplary embodiment.

### DETAILED DESCRIPTION OF THE PREFERRED EMBODIMENTS

An improved online bidding system and method for buyers to purchase vehicles from car dealerships and/or brokers is described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

Generally, the exemplary online bidding system and method provide consumers the opportunity to receive the best price for a vehicle by allowing dealerships to compete for a sale. The exemplary online bidding system and method also allow consumers to save time and money when buying a new car. The exemplary online bidding system and method brings consumers and multiple dealerships together to ultimately provide a serious buyer with a best offer. The exemplary online bidding system and method is beneficial to all parties by saving time and money.

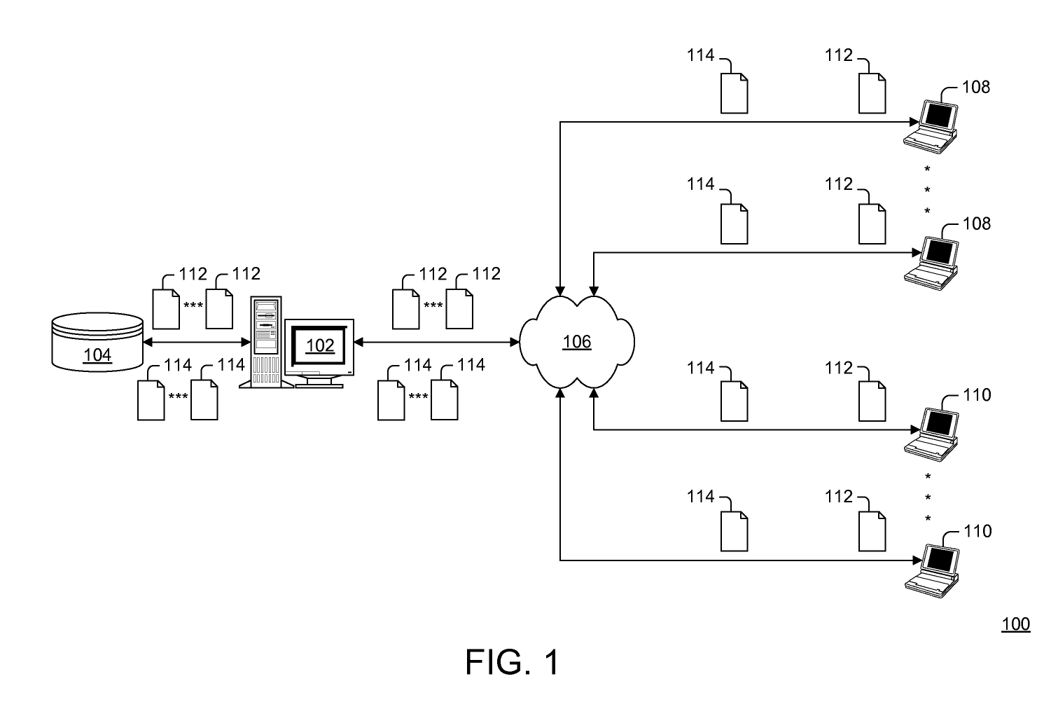

Referring now to the drawings, FIG. 1 thereof illustrates an exemplary online bidding system for vehicle purchases, according to an exemplary embodiment. In FIG. 1, the exemplary online bidding system 100 can include a server 102 having a database 104 coupled over communications network 106 (e.g., the Internet) to one or more vehicle buyer client devices 108 and one or more vehicle seller client devices 110. The vehicle buyers 108 submit vehicle requests 112 that are stored by the server 102 in the database 104 and received over the communications network 106 by the vehicle sellers 110. The vehicle sellers 110 submit bids 114 corresponding to the vehicle requests 112 and which are stored in the database 104 by the server 102 and sent to the vehicle buyers 108. The vehicle buyers 108 can select a winning bid 114, wherein the corresponding vehicle seller 110 is notified by the server 102 of the winning bid 114, so that the vehicle seller 110 can complete the sale of the vehicle with the vehicle buyer 108.

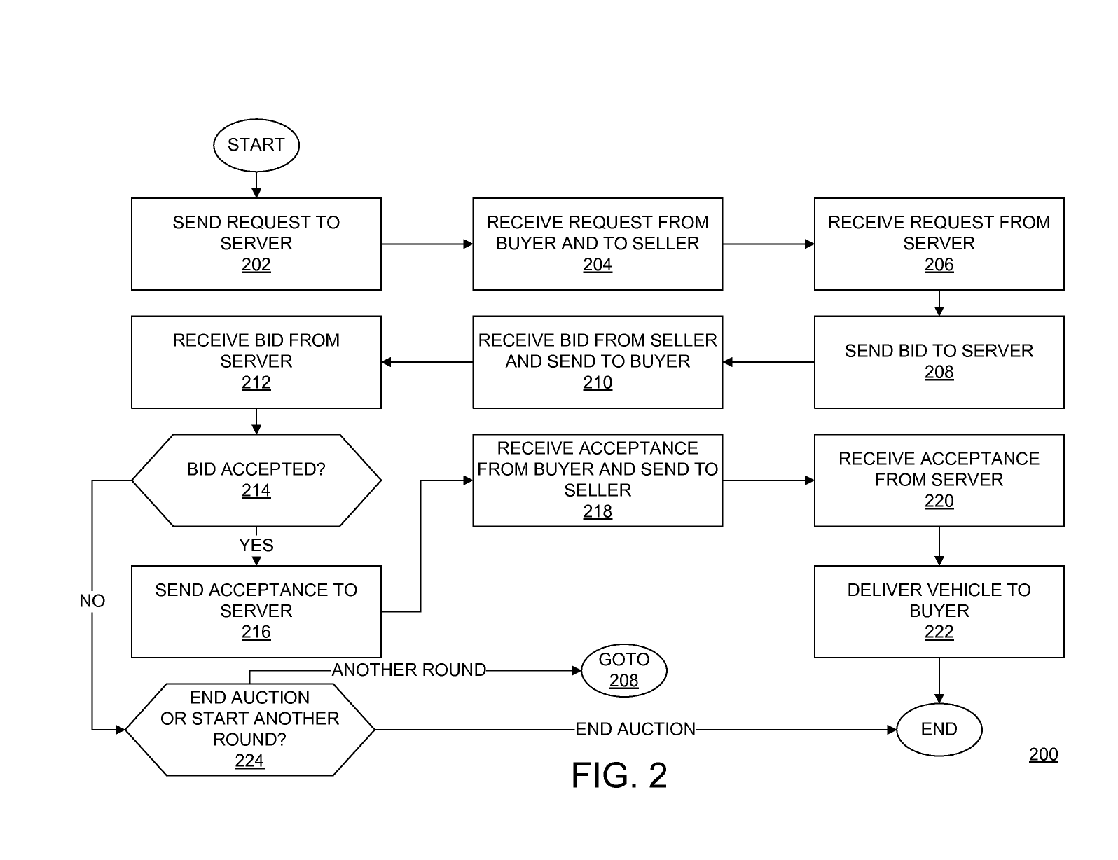

FIG. 2 illustrates an exemplary online bidding method for vehicle purchases corresponding to the system of FIG. 1, according to an exemplary embodiment. In FIG. 2, the exemplary online bidding method 200 includes the buyer sending the vehicle request to the server at step 202. The server receives the vehicle request from the buyer and transmits the vehicle request to the sellers at step 204. At step 206, the sellers receive the vehicle request from the server. If a seller is interested in bidding on the vehicle, the seller sends a bid to the server at step 208. At step 210, the server receives the bid from the seller and transmits the bid to the buyer. At step 212, the buyer receives the bid from the server, and a determination is made as to whether or not to accept the bid at step 214. If the bid is accepted, the buyer sends an acceptance to the server at step 216. At step 218, the server receives the acceptance from the buyer and sends the acceptance to the winning seller. At step 220, the winning seller receives the acceptance from the server and can complete the purchase, for example, including delivering vehicle to the buyer or having the buyer pickup the vehicle at step 222, completing the process. If, however, the buyer decides not to accept the bid, at step 224 the buyer can decide to end or continue the auction. If the auction is continued, control returns to step 208, so that the sellers can submit further bids. If, however, the buyer decides to end the auction, the processing is completed.

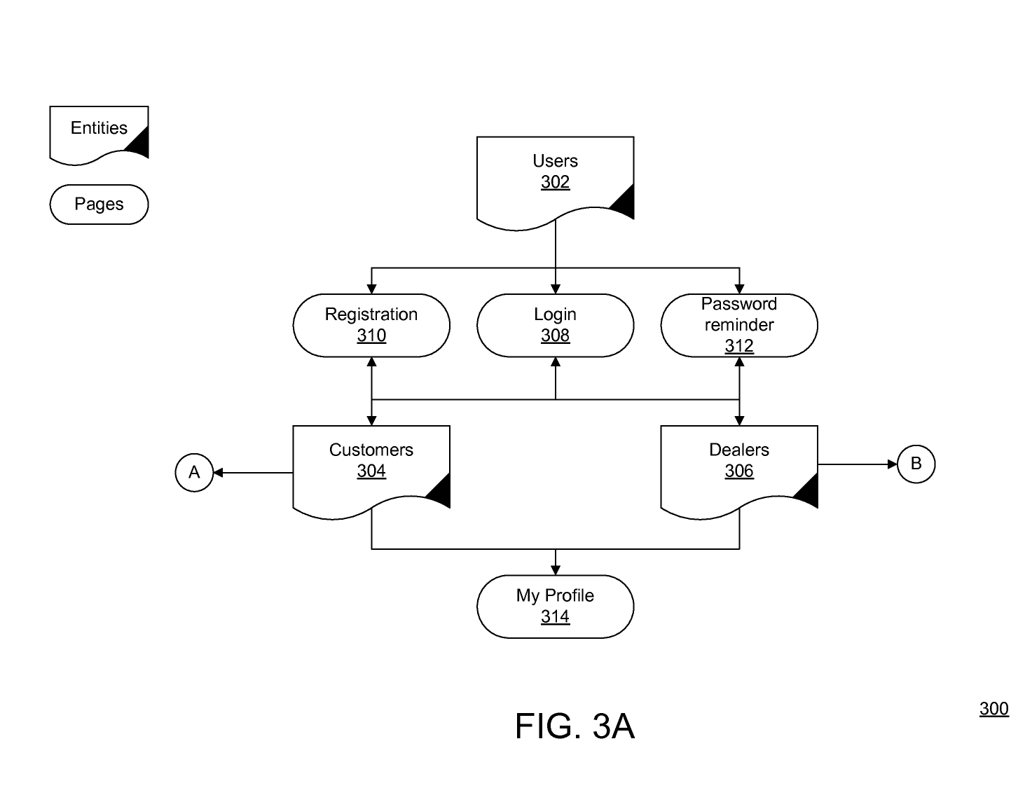

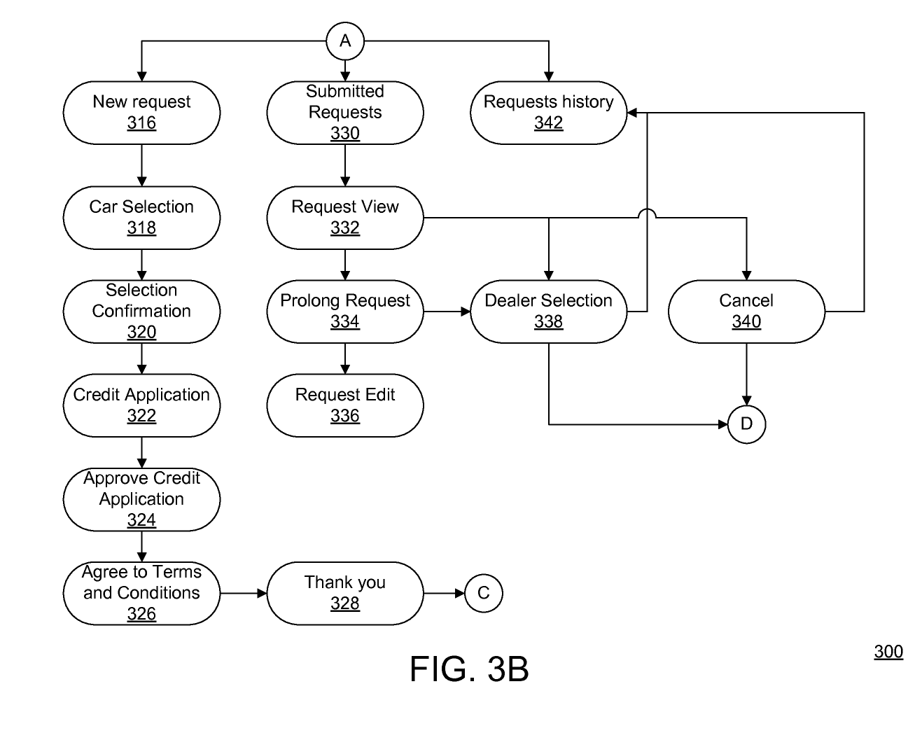

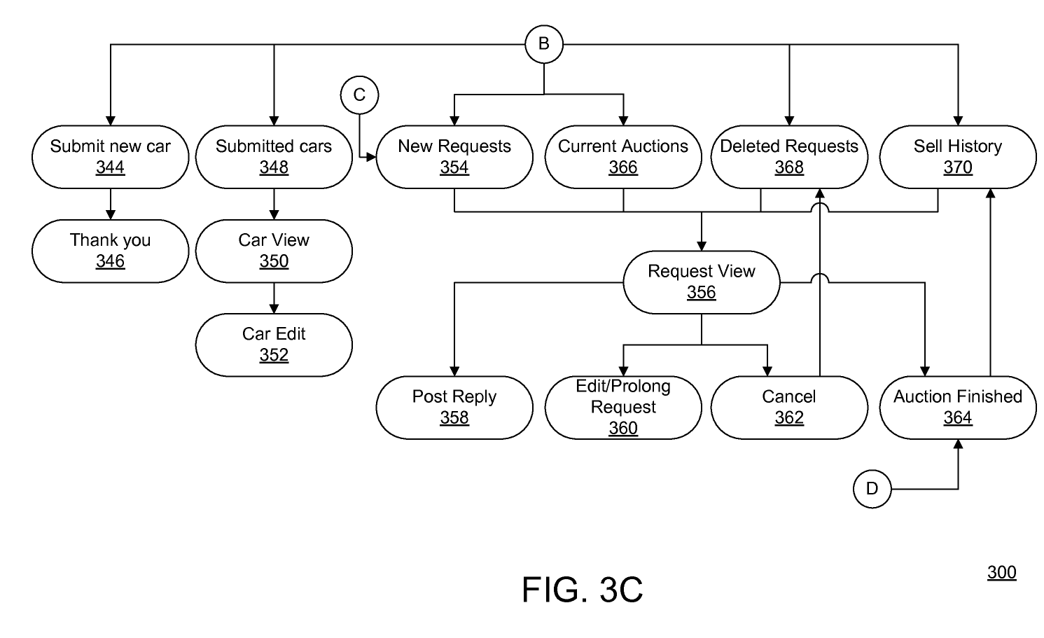

FIGS. 3A-3C illustrate exemplary web pages of the exemplary online bidding system and method for vehicle purchases of FIGS. 1-2, according to exemplary embodiments. In FIGS. 3A-3C, the exemplary web pages 300 (e.g., of the server 102) are provided for users 302, including customers 304 (e.g., the vehicle buyers 108 of FIG. 1) and dealers 306 (e.g., the vehicle sellers 110 of FIG. 1). The customers 304 and the dealers 306 have access to a login page 308 for logging in users into the server 102, a registration page 310 for registering users with the server 102, a password reminder page 312 for resetting or reminding users of their password, and a profile page 314 for allowing users to fill in their profile information.

The customers 304 also have access to a new request page 316 for submitting a new request for vehicle, a submitted requests page 330 for viewing submitted requests, and a requests history page 342 for viewing a history of submitted requests. The new request page 316 includes a car selection page 318 for selecting a car to be bid on, a selection confirmation page 320 for confirming the selected car, a credit application page 322 for submitting a credit application, an approved credit application page 324 for notification of an approved credit application, an agree to terms and conditions button 326 for approving of the terms and conditions, and a confirmation page 328 for confirming the transactions.

The submitted requests page 330 includes a request view page 332 for viewing of the submitted requests, a prolonged request page 334 for prolonging a submitted request, and a request edit page 336 for editing a submitted request. The request view page 332 and the prolonged request page 334 are linked to a dealer selection page 338 for selecting a dealer and which is linked to the requests history page 342. The request view page 332 also is linked to a cancel button 340 for canceling a transaction and which is linked to the requests history page 342.

The dealers 306 also have access to a submit new car page 344 for submitting a new car, a submitted car page 348 for viewing submitted cars, and a new requests page 354 linked to page 328 for viewing submitted requests, a current auctions page 366 for viewing current auctions, a deleted requests page 368 for viewing deleted requests, and a sell history page 370 for viewing a history of sales. The submit new car page 344 includes a confirmation page 346 for confirming the transactions.

The submitted cars page 348 includes a car view page 350 for viewing the details of a submitted car, and a car edit page 352 for editing the details of a submitted car. The new requests page 354, the current auctions page 366, the deleted requests page 368, and the sell history page 370 are linked to a request view page 356 for viewing a submitted requests and which is linked to a post reply page 358 for posting replies, and edit/prolonged request page 360 for editing or prolonging a request, a cancel button 362 for canceling transactions and which is linked to page 368, and an auction finished page 364 for indicating the end of an auction in which is linked to pages 338, 340 and 370.

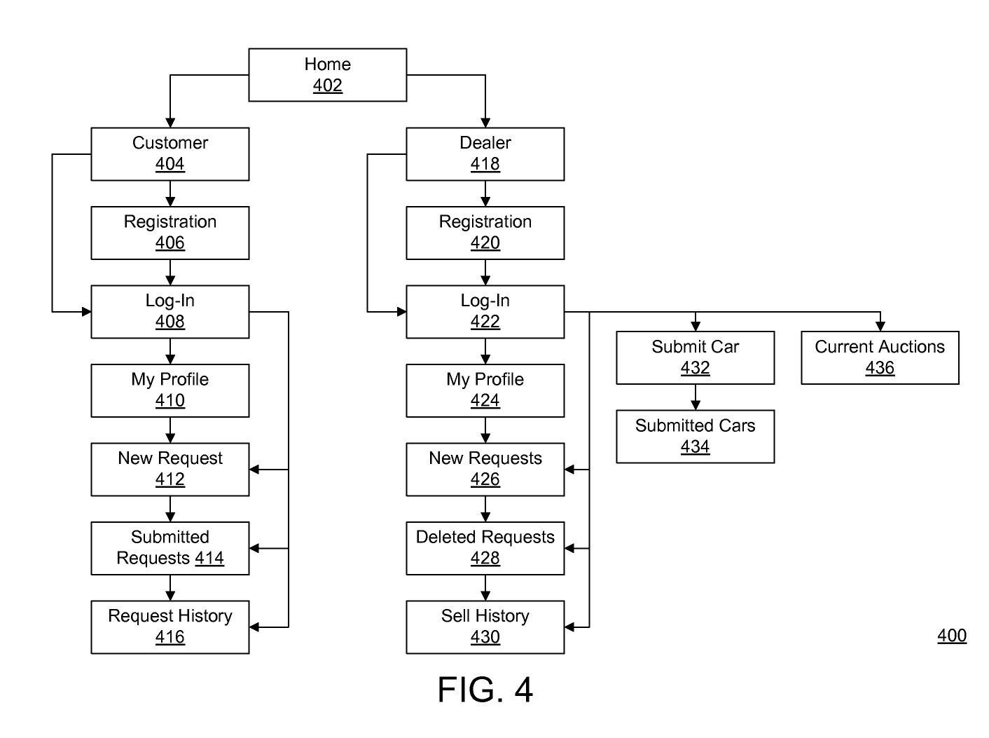

FIG. 4 illustrates exemplary web page navigation for the exemplary online bidding system and method for vehicle purchases of FIGS. 1-3, according to exemplary embodiments. In FIG. 4, the exemplary web page navigation 400 hosted on a web server (e.g., a server 102), for example, includes a homepage 402 for commencing navigation, a customer page 404 for entering customer details (e.g., for customers 304), and a dealer page 418 for entering dealer details (e.g., for dealers 306). The customer pages 404 and 418 can include registration pages 406 and 420 for entering customer and dealer registration details, respectively, login pages 408 and 422 for logging in customers and dealers, respectively, profile pages 410 and 424 for entering profile details for customers and dealers, respectively, and new request pages 412 and 426 for entering and viewing submitted car requests by the customers and viewing submitted car requests by the dealers, respectively.

The customer page 404 also includes a submitted requests page 414 for viewing submitted requests, and a request history page 416 for viewing a history of submitted requests. The dealer page 418 also includes a deleted requests page 428 for viewing requests that have been deleted, a sell history page 430 for viewing a history of car sales, a submitted car page 432 for submitting a car, a submitted cars page 434 for viewing submitted cars, and current auctions page 436 for viewing current auctions. The customer page 404 can be linked to the login page 408, which is linked to the new request page 412, the submitted requests page 414, and the request history page 416. The dealer page 418 can be linked to the login page 422, which is linked to the new requests page 426, the deleted requests page 428, the sell history page 430, the submit car page 432, and the current auctions page 436.

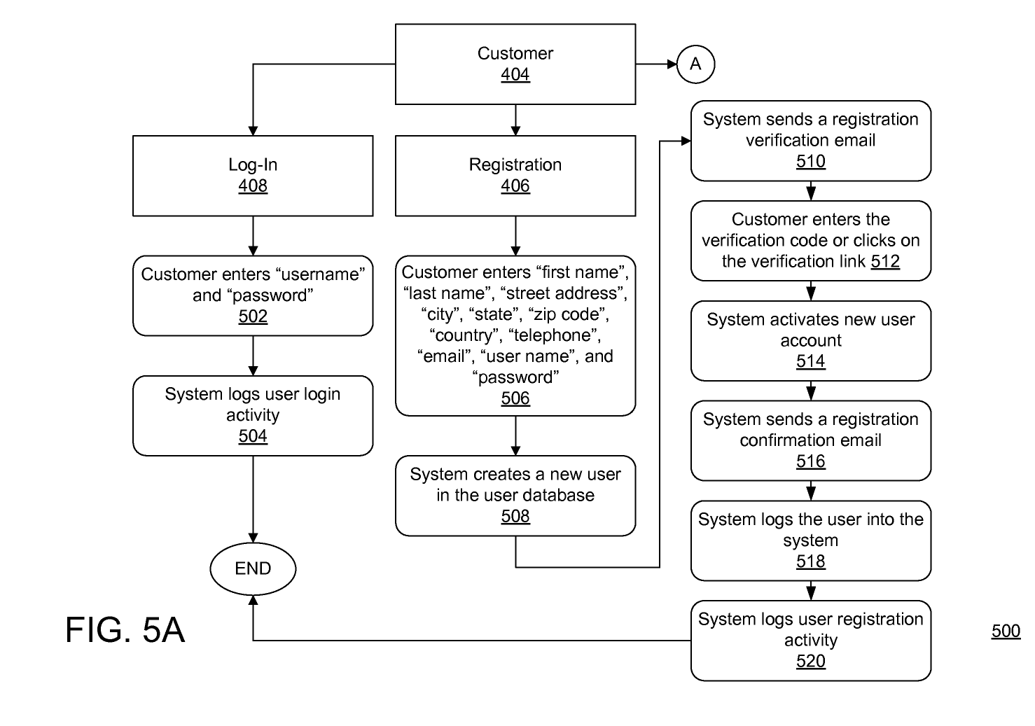

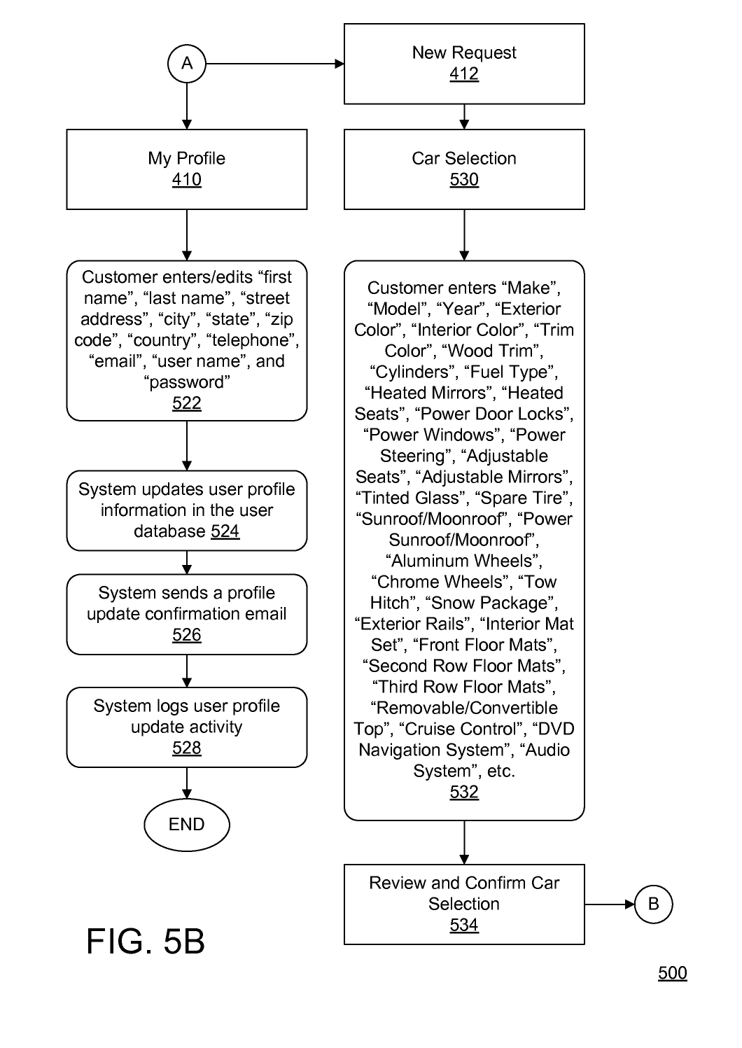

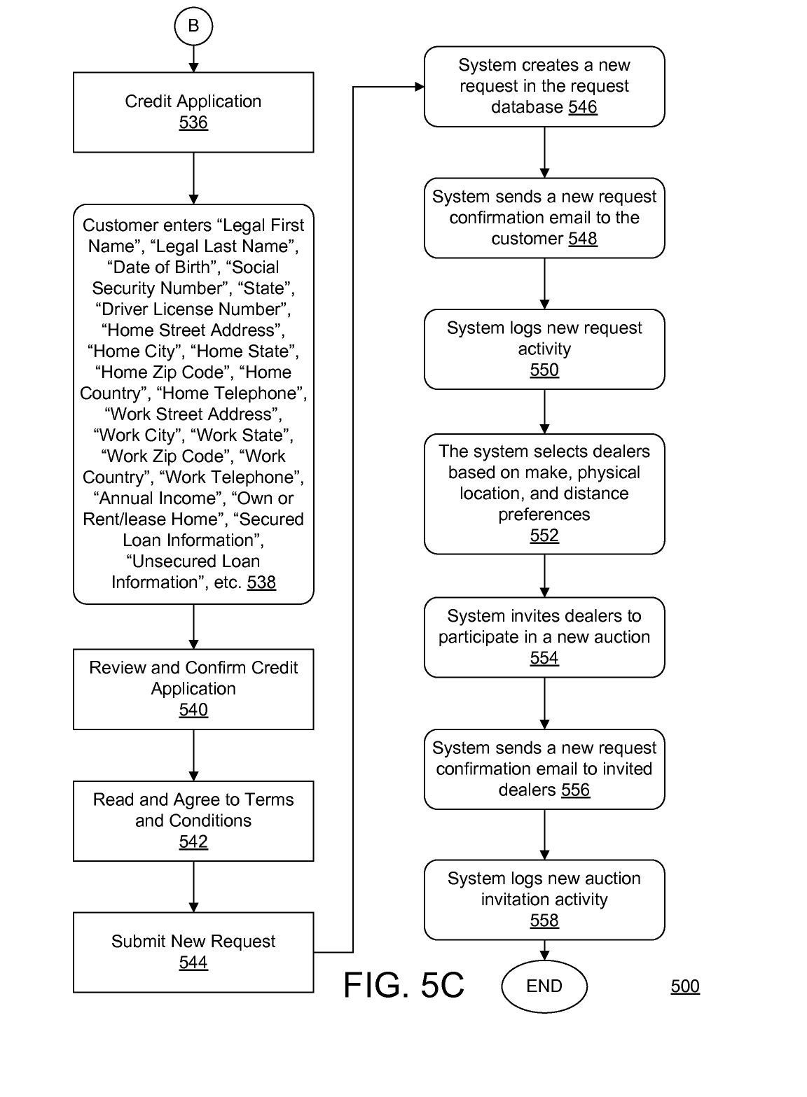

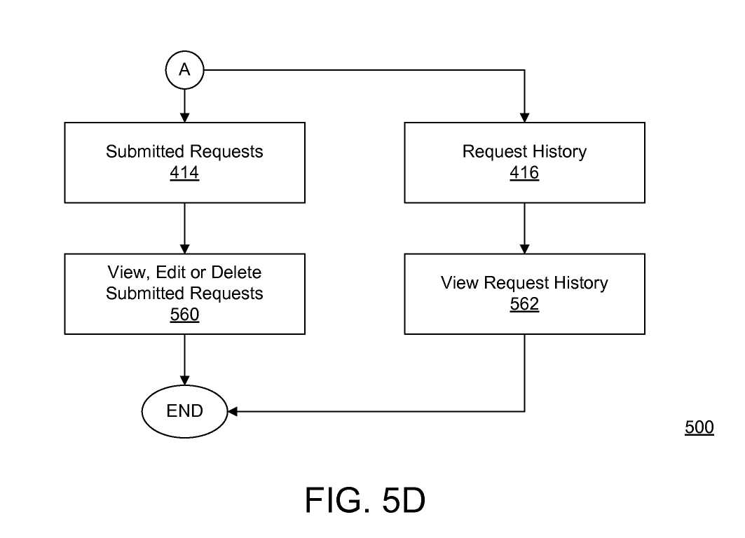

FIGS. 5A-5D illustrate details of the exemplary online bidding system and method for vehicle purchases of FIGS. 1-4 for a customer, according to exemplary embodiments. In FIGS. 5A-5D, the exemplary customer process 500 can include a customer 404 registration process 406, login process 408, profile process 410, new request process 412, submitted requests process 414, and request history process 416. The customer login process 408 can include a customer entering a username and password at step 502, and the system logging the user log in activity at step 504, completing the process.

The customer registration process 406 can include the customer entering various customer information at step 506, the system creating a new user in the user database at step 508, the system sending a registration verification e-mail to the customer at step 510, the customer entering a verification code or clicking on a verification link from the e-mail at step 512, the system activating the new user account at step 514, the system sending a registration confirmation e-mail to the customer at step 516, the system logging the user into the system at step 518, and the system logging the user registration activity at step 520, completing the process.

The profile process 410 can include the customer entering various profile information at step 522, the system updating the user profile information in the user database at step 524, the system sending a profile update confirmation e-mail to the customer at step 526, and the system logging in the user profile update activity at step 528, completing the process.

The new request process 412 can include the customer making a car selection at step 530, including entering various details for the car at step 532, reviewing and confirming the car selection at step 534, wherein control is transferred to a credit application process 536, including the customer entering various credit application details at step 538, the customer reviewing and confirming the credit application at step 540, the customer reading and agreeing to the terms and conditions at step 542, the customer submitting the new request at step 544, the system creating a new request in the requests database at step 546, the system sending a new request confirmation e-mail to the customer at step 548, the system logging in the new request activity at step 550, wherein control is transferred to a dealer selection process at step 552, including the system inviting dealers to participate in a new auction at step 554, the system sending a new request confirmation e-mail to the invited dealers at step 556, and the system logging in the new auction invitation activity at step 558, completing the process.

The submitted requests process 414 can include the customer being able to view, edit or delete submitted requests at step 560, completing the process, and the request history process 416 can include the customer being able to view submitted requests history at step 562, completing the process.

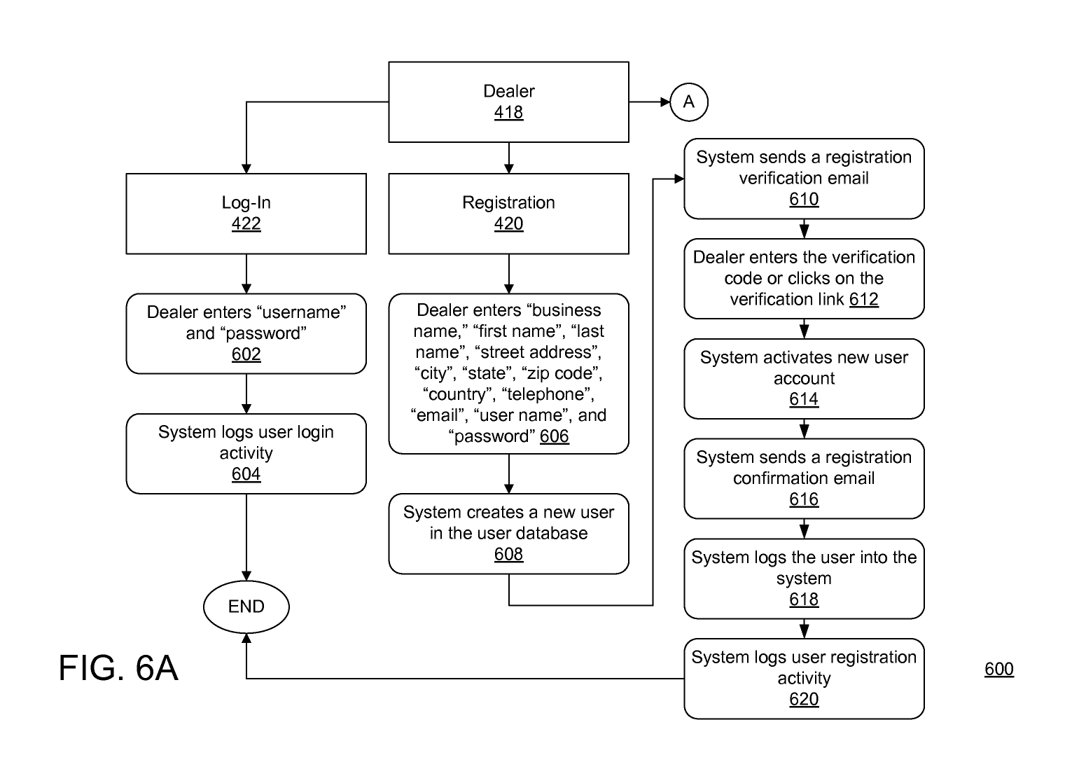

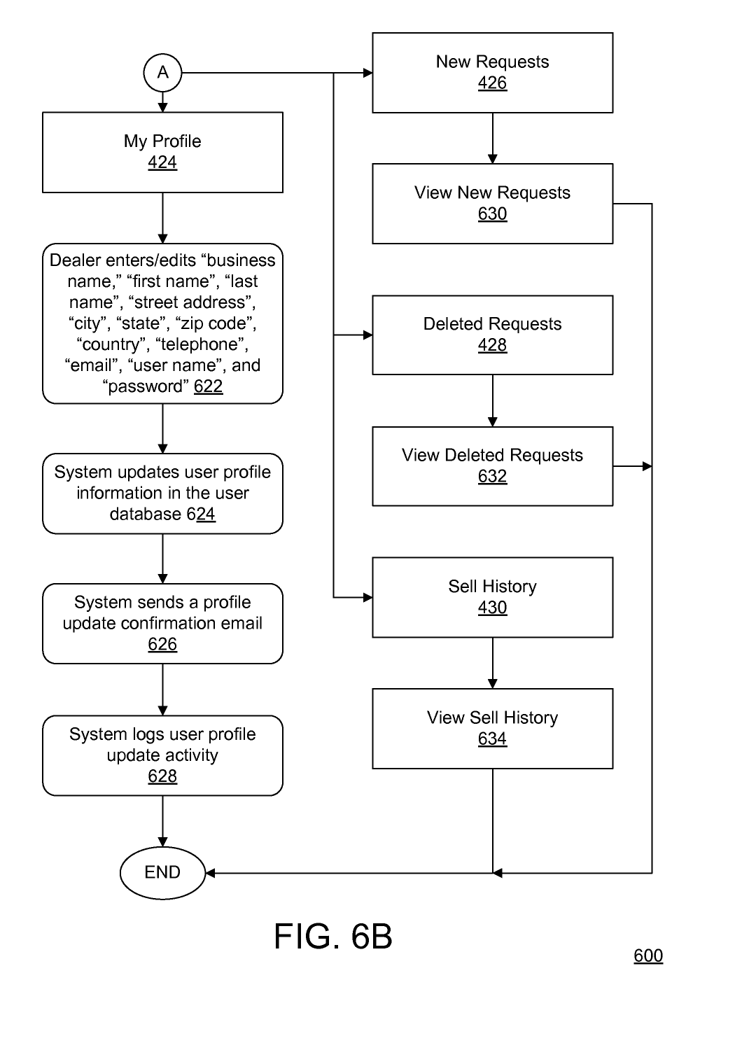

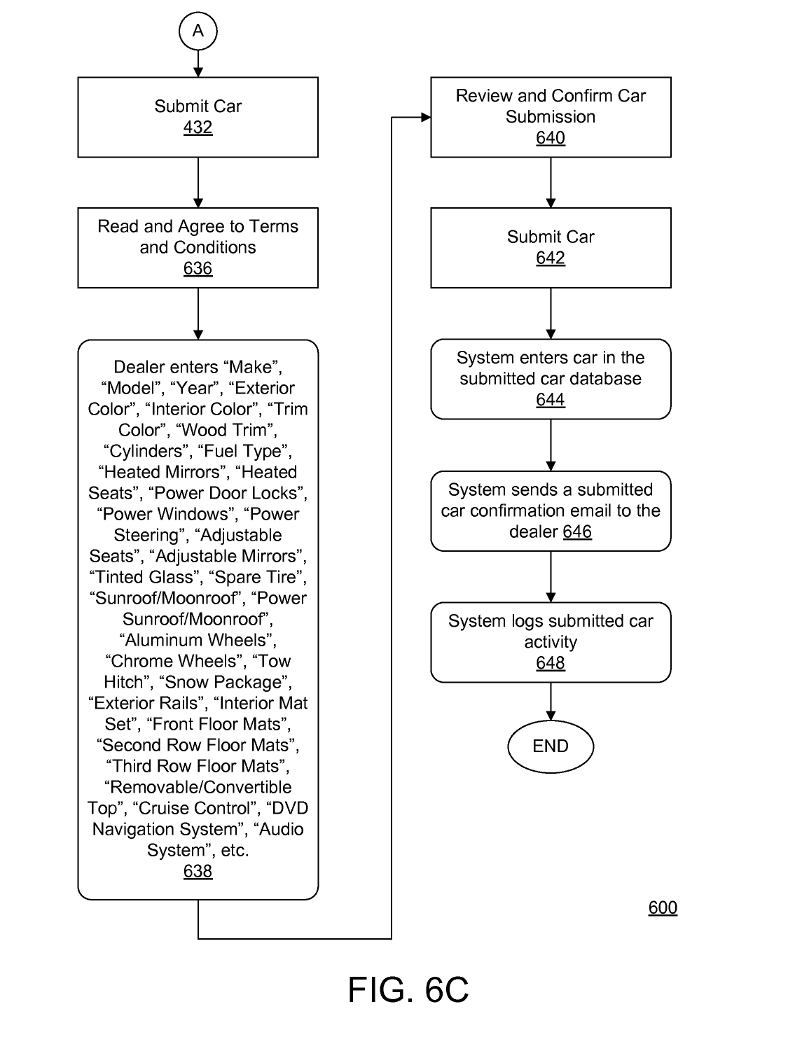

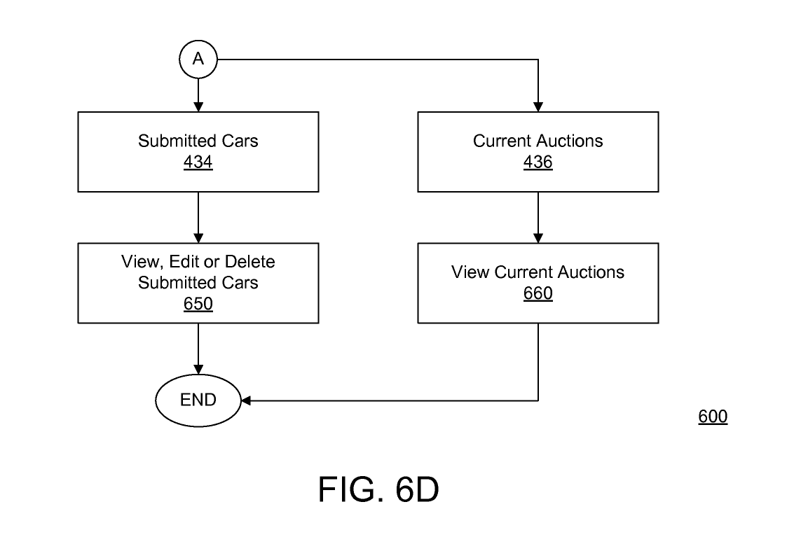

FIGS. 6A-6D illustrate details of the exemplary online bidding system and method for vehicle purchases of FIGS. 1-4 for a dealer, according to exemplary embodiments. In FIGS. 6A-6D, the exemplary dealer process 600 can include a dealer 418 registration process 420, login process 422, profile process 424, new requests process 426, deleted requests process 428, sell history process 430, submit car process 432, submitted cars process 434, and current auctions process 436. The dealer login process 422 can include a dealer entering a username and password at step 602, and the system logging the user log in activity at step 604, completing the process.

The dealer registration process 418 can include the dealer entering various dealer information at step 606, the system creating a new user in the user database at step 608, the system sending a registration verification e-mail to the dealer at step 610, the dealer entering a verification code or clicking on a verification link from the e-mail at step 612, the system activating the new user account at step 614, the system sending a registration confirmation e-mail to the dealer at step 616, the system logging the user into the system at step 618, and the system logging the user registration activity at step 620, completing the process.

The profile process 424 can include the dealer entering various profile information at step 622, the system updating the user profile information in the user database at step 624, the system sending a profile update confirmation e-mail to the dealer at step 626, and the system logging in the user profile update activity at step 628, completing the process.

The new requests process 426 can include the dealer being able to view submitted requests at step 630, completing the process, the deleted requests process 428 can include the dealer being able to view the deleted requests at step 632, completing the process, and the sell history process 430 can include the dealer being able to view the sell history at step 634, completing the process.

The submit car process 432 can include the dealer agreeing to the terms and conditions at step 636, the dealer entering various details of the car to be submitted at step 638, the dealer reviewing and confirming the car submission at step 640, the dealer submitting the car at step 642, the system entering the car in the submitted car database at step 644, the system sending a submitted car confirmation e-mail to the dealer at step 646, and the system logging the submitted car activity at step 648, completing the process.

The submitted cars process 434 can include the dealer being able to view submitted cars at step 650, completing the process, and the current auctions process 436 can include the dealer being able to view current auctions at step 660, completing the process.

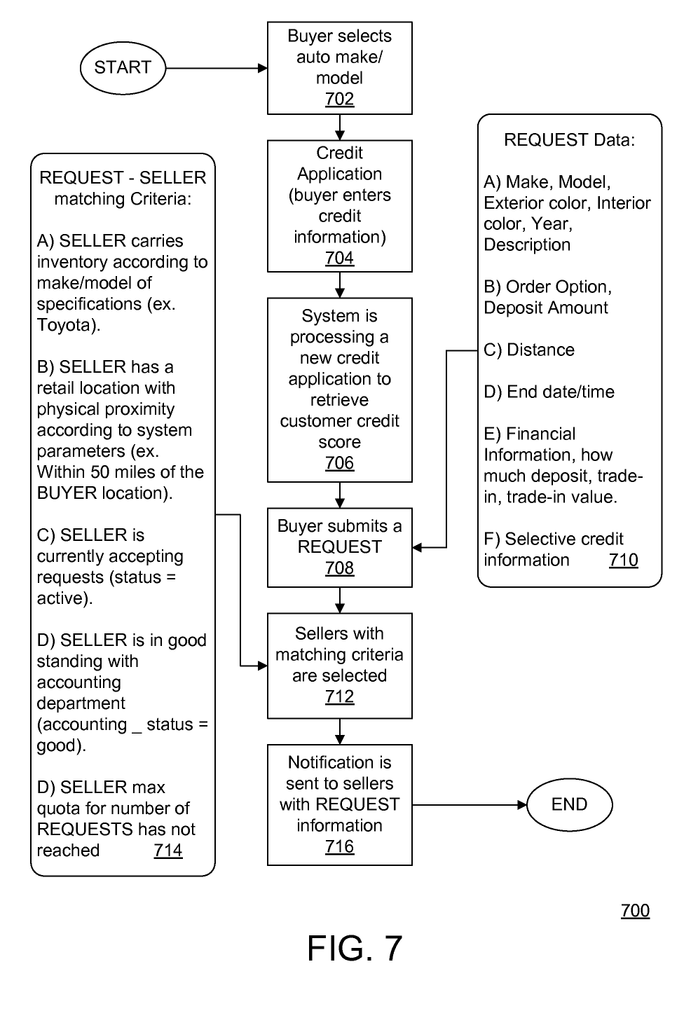

FIG. 7 illustrates further details of the exemplary online bidding system and method for vehicle purchases of FIGS. 1-6 for a buyer, according to an exemplary embodiment. In FIG. 7, the buyer process 700 includes the buyer selecting a vehicle make and/or model at step 702, the buyer submitting a credit application at step 704, the system processing the credit application and retrieving a credit score at step 706 and upon credit approval the buyer submitting a car request at step 708, based on exemplary request data 710, the system selecting sellers with matching criteria at step 712, based on exemplary seller criteria 714, and the system sending a notification to all sellers including the submitted request information at step 716, completing the process.

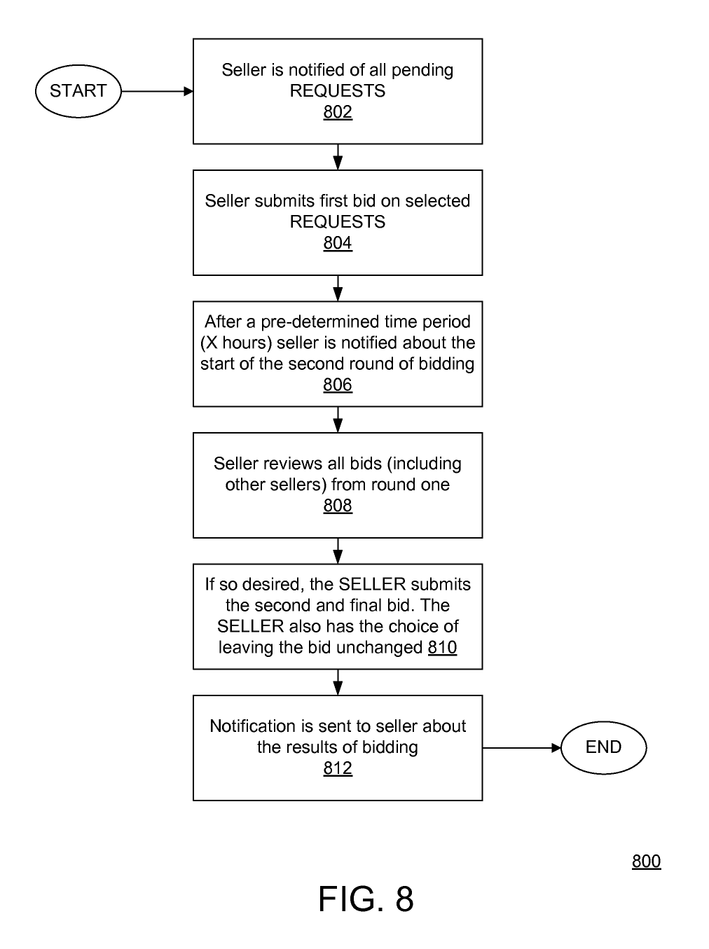

FIG. 8 illustrates further details of the exemplary online bidding system and method for vehicle purchases of FIGS. 1-6 for a seller, according to an exemplary embodiment. In FIG. 8, the seller process 800 includes the seller being notified of all pending requests at step 802, the seller submitting a first bid on a selected request at step 804, if no bids are won, after a predetermined time period, the seller being notified about the start of the second round of bidding at step 806, the seller reviewing all bids from round one including bids from other sellers at step 808, the seller submitting a second final bid or leaving a bid unchanged at step 810, and the system sending a notification to the seller about the results of the bidding at step 812, completing the process.

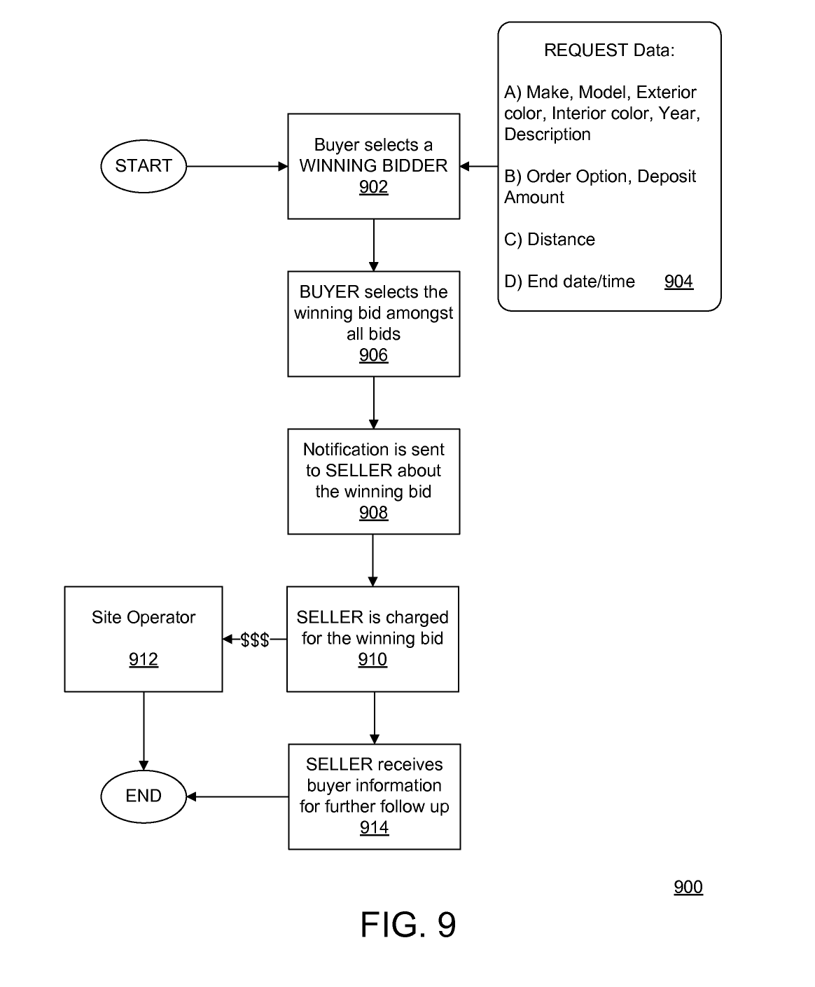

FIG. 9 illustrates further details of the exemplary online bidding system and method for vehicle purchases of FIGS. 1-6 for a winning bid, according to an exemplary embodiment. In FIG. 9, the winning bid process 900 can include the buyer selecting a winning bidder at step 902, based on request data 904, including the buyer selecting the winning bid amongst all of the bids step 906, the system sending a notification to the seller about the winning bid at step 908, the seller being charged by the system for winning the bid (e.g., based on a percentage of the sale price, a fixed price, etc.) at step 910, the charged funds being transferred from the seller to the operator of the system at step 912, and the seller receiving information about the buyer for further follow-up to complete the sale at step 914, completing the process.

Accordingly, in order for a customer to participate in the online system of FIGS. 1-9, the process for a customer can include registering online for a customer account, logging with a username and password, selecting a desired car make/model and other specifications that customer is shopping for, selecting applicable options to purchase, lease, trade-in (e.g., with description and approximate value), down payment amount, etc., completing a credit check application (e.g., with only pertinent information shared with sellers, for example, including the usernames for the customers), and reviewing and confirming the entered information before final submission and agreement to terms and conditions for the auction.

In an exemplary embodiment, the online system can select dealerships, for example, based on proximity and/or other selection criteria, wherein request for participation can be sent to the selected dealerships for bidding. Similarly, the process for a participating dealership can include registering for an online account, logging into the system with a username and password, once logged in having access to the pertinent information of customers (e.g., not including social security number, address, telephone number, etc., to protect the consumer), navigating to the new requests page for selecting to bid on new requests, submitting a bid price and providing comments and/or offers that are relevant to the bid, and reviewing and confirming the entered information before final submission and agreement to the terms and conditions for the auction.

In an exemplary embodiment, after a first bid is submitted, the submitted bidding activity can be displayed on a bidding section webpage and can be visible by all participating parties. Advantageously, this feature can motivate dealers to under bid their competitor to obtain a sale. To ensure fairness and an open atmosphere, communication between the customer and competing dealers can be conducted via the online website and can be visible to all parties.

In an exemplary embodiment, after the first round of bidding is completed, a second round of bidding can commence, allowing the participating sellers to enter a second and final bid. In further exemplary embodiments, the bidding can go through multiple rounds until, for example, the auction is ended by the buyer and/or a preset time limit has been reached. After the bidding ends, the customer can choose a desired bid. Once the seller (e.g., dealership) is awarded the bid, the seller can receive an email from the online system with the corresponding customer's contact information. The awarded dealer can then contact the customer via the online system and/or via phone, for example, to finalize a contract and/or additional paperwork for financing. The customer can pick up the car and/or the dealership can offer to deliver the vehicle to customer.

Accordingly, the system and method of FIGS. 1-9 allows sellers and buyers to participate in an online auction, for example, including the following characteristics.

Reverse Bidding—The auction can be based on reverse bidding, meaning that sellers submit bids and not the buyers.

Underbidding—The lowest bid or the most attractive bid chosen by a buyer can be considered a winning bid.

Multi-round bidding—Sellers participate in multiple (e.g., two) rounds of bidding. After the first round, the sellers are given access to see the bids submitted by other sellers. Advantageously, this is done in order to give sellers a chance to submit their best bid and at the same time stay competitive in the auction.

Accordingly, In an exemplary embodiment, the systems and methods of FIGS. 1-9 facilitate the following exemplary workflows for buyers and sellers. For example, the customer workflow can include the customer registering and logging into the system, navigating to the new request submittal page, selecting and/or entering the desired car make/model and other specifications being shopped for, choosing an option of buying or leasing, etc., as well as specifying any trade-ins, a desired car make/model, approximate value, down payment amount, etc., filling out application for a credit check with minimal of the credit information being shared with the sellers, reviewing and confirming the entered information before a final submission, and agreement to the relevant terms and conditions for the auction.

In an exemplary embodiment, the system can select dealers based on proximity and/or other selection criteria, and can notify the dealers about new requests, can display sellers with a specified car in their inventory. For example, based on proximity, the customer can select desired dealers from the displayed list to be invited to the bidding process. After the bidding is complete, the customer can select a desired bid/offer, and can be contacted via the system by the awarded seller to finalize the sale.

In an exemplary embodiment, the seller bidding process can include the seller registering and logging into the system, uploading and/or updating the inventory information of the seller, being notified about new requests submitted by customers, navigating to the new/pending requests page, reviewing and selecting a request to bid on a request, entering bid information (e.g., price, vehicle details, etc.), wherein the seller can specify additional comments and/or offers that are relevant to the bid, reviewing and confirming the entered information before final submission, and agreement to the terms and conditions for the auction.

In an exemplary embodiment, after submitting the first offer, other sellers' bids and offers become visible to the seller for comparison purposes, wherein after a first round of bidding is complete, a second round of bidding starts, which gives participating sellers a chance to enter their second and final bids. In this case, the sellers can enter bid information similar to that of round one. The sellers can then review and confirm the second bid information before final submission.

Once a seller is awarded a bid, the seller can receive a notification via any suitable means (e.g., via email, short message service (SMS), instant messaging (IM), phone calls, voicemails, etc.) from the online system with the corresponding customer's contact information. The seller can then contact the customer to finalize the sale.

In an exemplary embodiment, the online system can send various notifications and/or alerts via any suitable means (e.g., via email, short message service (SMS), instant messaging (IM), phone calls, voicemails, etc.), for example, including registration verifications, registration confirmations, password reset links, password change confirmations, profile change confirmations, new request confirmation to customers, new requests notification to dealers, customer notifications when a bid is submitted, dealer bid confirmations (e.g., for round one and round two), customer bid selection confirmations, dealer notifications when a bid is awarded, bid award notifications with buyer/customer contact information, and credit score validation process notifications.

During a request submittal, after selecting a desired make/model of the vehicle, the user can fill out a credit application, wherein the credit information can be processed by the system to verify credit score. The credit score can be used to rate customers, for example, in order to provide incentives for the sellers to participate in auctions based on customer/buyer ratings with within the system.

In an exemplary embodiment, the system also can facilitate various administrative function, for example, including creating new users, deleting users, suspending users, activating users, resetting user names and/or passwords, adding administrative notes to user profiles, sending notifications to users, editing of car types (e.g., adding new models, editing specifications, deleting old models, uploading images, etc.), adding, removing, and/or editing advertisements and banners, adding, removing, and/or editing payment methods and accounts, changing system parameters, configuring the system into read-only mode, blocking the access to the system, backing up system databases, exporting database information, and viewing and/or exporting system logs.

Accordingly, In an exemplary embodiment, the systems and methods of FIGS. 1-9 can include the dealer registration process, for example, including the dealer filling out a registration application, confirming and/or agreeing to the terms and conditions and submitting the application for approval, receiving an e-mail from the system with the application confirmation, confirming the e-mail address of the dealer, the system verifying approving or disapproving the dealer account, the system creating an account for the dealer in the database, and notifying the dealer of account approval.

In an exemplary embodiment, the dealer login process can include the dealer accessing their profile, making changes to the profile, confirming and/or agreeing to terms and conditions and submitting information for approval, the system sending a notification of any changes, approving or disapproving any changes, and the system sending relevant notifications and or alerts to the dealer. The dealer can also submit inventory, for example, via automatic upload from the dealers website, can view submitted inventory, can add, remove and/or edit inventory with the system sending relevant notifications and alerts (e.g., for activities, updates, auction status, customer requests, etc.). The dealer can also review new customer requests (e.g., with the customer's limited information, requested car with details, etc.). The system can display to the dealer the number of participating dealers, can allow the dealer to reply on a request and/or make an offer, allow the dealer to confirm customer requests and/or agree to terms and conditions and submit offers, send notifications of submissions of the new offers to the buyers, allow the dealers to review submitted offers by participating dealerships and/or competitors, and delete customer requests (e.g., if the dealer is not interested) with the system having the dealer confirm the deletion and sending the requests to the deleted requests page.

In an exemplary embodiment, the system allows dealers to view current auctions, including reviewing submitted offers and/or offers in progress of current auctions, making new offers, confirming requests and/or agreeing to terms and conditions and/or submitted offers with the system sending notifications and/or confirmations. The system also allows the dealers to view sell history, which the system saves in database archive, view deleted requests, including opening and/or reviewing deleted requests and/or auctions, permanently deleting deleted request and/or auctions with the system having the dealer confirm permanent deletion and after confirmation by the dealer permanently deleting the relevant information from the database.

In an exemplary embodiment, the system provides an auction process, for example, including a first round of bidding, wherein the participating dealers enter the bid section of the online system after submitting an offer with the system sending relevant notifications and making a submitted offer visible to the customers and the participating dealers. Then, if no bid selected by the customer, the first round of bidding is closed and the system continues on to a second round of bidding, wherein the system gives an option to the customer to either select a desired offer or continue on to the second round of the auction. The system then atomically opens the second part of the auction, if no response is received from the customer to the contrary, wherein the system sends a notification of the closing of the first round of bidding and the starting of the second round of bidding of the auction to the customer and the participating dealers.

The second part of the auction proceeds in a manner similar to the first part of the auction, wherein if no winning bid is selected by the customer, the system sends appropriate notifications to the customer and the participating dealers. In an exemplary embodiment, the system gives the customer a chance to choose a desired offer before ending the auction. If the customer selects and submits a desired offer, the system verifies the submission, confirms the verification with the system sending appropriate notifications to the customer (e.g., with the contact information for the corresponding dealer, verification of the auction, etc.), the winning dealer (e.g., with the contact information for the customer, verification of the auction, etc.), and all the other participating dealers that did not win their bids (e.g., a notification message of “SORRY, YOU DIDN'T GET AWARDED”).

Accordingly, In an exemplary embodiment, the systems and methods of FIGS. 1-9 can include the customer registration process, for example, including the customer filling out a registration application, confirming and/or agreeing to the terms and conditions and submitting the application for approval, receiving an e-mail from the system with the application confirmation, confirming the e-mail address of the customer, the system verifying approving or disapproving the customer account, the system creating an account for the customer in the database, and notifying the customer of account approval.

In an exemplary embodiment, the customer login process can include the customer accessing their profile, making changes to the profile, confirming and/or agreeing to terms and conditions and submitting information for approval, the system sending a notification of any changes, approving or disapproving any changes, and the system sending relevant notifications and or alerts to the customer. The customer can also enter a new request, wherein the customer enters and/or selects a desired vehicle (e.g., car, truck, RV, boat, etc., with options, etc.), buy, lease, and/or trade-in options, trade-in vehicle information, pictures to be uploaded, and down payment information, lease/buy terms (e.g., 24, 36, 39, 60 months etc.), and then saves and/or continues the process. The customer can also enter a credit application, including filling out a credit report application (e.g., including full name, address, phone numbers, driver's license number, Social Security number, etc.) with the system providing confirmation, including allowing the customer to review submitted information, agree to terms and conditions, and submit the information for bidding. The system then sends the customer's request to the participating dealerships new requests page with appropriate notifications for the customer and the participating dealers.

In an exemplary embodiment, with respect to the auctioning process, the system sends a notification to the customer once one or more of the dealers make one or more offers based on the submitted request, wherein the customer can review submitted offers by participating dealers and select a desired offer and/or dealer and/or prolong the auction. If the customer selects a desired offer and/or dealer, the system sends a customer confirmation of the selection, wherein the customer verifies a confirmation with the system sending an appropriate notification to the customer, the winning dealer, and the non-winning dealers, as previously described.

The above-described devices and subsystems of the exemplary embodiments can be accessed by or included in, for example, any suitable servers, clients, workstations, PCs, laptop computers, PDAs, Internet appliances, handheld devices, cellular telephones, wireless devices, other devices, and the like, capable of performing, accessing or employing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like

It is to be understood that the devices and subsystems of the exemplary embodiments are for exemplary purposes, as many variations of hardware and/or software used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Although the exemplary embodiments are described in terms of online systems and methods for vehicle auctions, such as car auctions, and the like, the exemplary embodiments can be applied to any suitable types of auctions for any suitable types of products, as will be appreciated by those of ordinary skill in the relevant art(s).

While the present invention have been described in connection with a number of exemplary embodiments and implementations, the present invention is not so limited, but rather covers various modifications and equivalent arrangements, which fall within the purview of the appended claims.

What is claimed is:

1. An online bidding system for vehicle purchases, the system comprising:
a server configured to receive a vehicle request specifying a vehicle desire to be purchased from a buyer computer device;
the server being configured to transmit the vehicle request to one or more computer devices of vehicle sellers;
the server being configured to receive bids based on the vehicle specified in the vehicle request from the computer devices of the vehicle sellers; and
the server being configured to display bids received from the one or more computer devices of the vehicle sellers on the computer device of the buyer and the computer devices of the vehicle sellers.

2. The system of claim 1, wherein the server is configured to receive from the computer device of the buyer an acceptance of a bid of the received bids and forward the bid acceptance to the corresponding computer device of the vehicle seller that made the accepted bid.

3. The system of claim 1, wherein the server is configured to allow one or more rounds of bidding from the computer devices of the vehicle sellers.

4. The system of claim 1, wherein the server is configured to receive from the computer device of the buyer an auction end request for ending the bidding from the computer devices of the vehicle sellers.

5. The system of claim 1, wherein the server, before commencing the bidding, is configured to qualify the buyer, based on credit information of the buyer received from the computer device of the buyer, and qualify the sellers, based on information regarding the sellers received from the computer devices of the sellers.

6. A computer implemented method for online bidding for vehicle purchases, the method comprising:
receiving by a server from a buyer computer device a vehicle request specifying a vehicle desire to be purchased;
transmitting by the server to one or more computer devices of vehicle sellers the vehicle request;
receiving by the server from the computer devices of the vehicle sellers bids based on the vehicle specified in the vehicle request; and
displaying by the server on the computer device of the buyer and the computer devices of the vehicle sellers bids received from the one or more computer devices of the vehicle sellers.

7. The method of claim 6, further comprising:
receiving by the server from the computer device of the buyer an acceptance of a bid of the received bids; and
forwarding by the server to the corresponding computer device of the vehicle seller that made the accepted bid the bid acceptance.

8. The method of claim 6, further comprising allowing by the server one or more rounds of bidding from the computer devices of the vehicle sellers.

9. The method of claim 6, further comprising receiving by the server from the computer device of the buyer an auction end request for ending the bidding from the computer devices of the vehicle sellers.

10. The method of claim 6, further comprising, the server, before commencing the bidding, qualifying the buyer, based on credit information of the buyer received from the computer device of the buyer, and qualifying the sellers, based on information regarding the sellers received from the computer devices of the sellers.

11. A computer program product for online bidding for vehicle purchases, and including one or more computer readable instructions embedded on a computer readable medium and configured to cause one or more computer processors to perform the steps of:
receiving by a server from a buyer computer device a vehicle request specifying a vehicle desire to be purchased;
transmitting by the server to one or more computer devices of vehicle sellers the vehicle request;
receiving by the server from the computer devices of the vehicle sellers bids based on the vehicle specified in the vehicle request; and
displaying by the server on the computer device of the buyer and the computer devices of the vehicle sellers bids received from the one or more computer devices of the vehicle sellers.

12. The computer program product of claim 11, further comprising:
receiving by the server from the computer device of the buyer an acceptance of a bid of the received bids; and
forwarding by the server to the corresponding computer device of the vehicle seller that made the accepted bid the bid acceptance.

13. The computer program product of claim 11, further comprising allowing by the server one or more rounds of bidding from the computer devices of the vehicle sellers.

14. The computer program product of claim 11, further comprising receiving by the server from the computer device of the buyer an auction end request for ending the bidding from the computer devices of the vehicle sellers.

15. The computer program product of claim 11, further comprising, the server, before commencing the bidding, qualifying the buyer, based on credit information of the buyer received from the computer device of the buyer, and qualifying the sellers, based on information regarding the sellers received from the computer devices of the sellers.
